(19) United States
(12) Patent Application Publication
(10) Pub. No.: US 2023/0067257 A1
(43) Pub. Date: Mar. 2, 2023

(54) COMPOSITION COMPRISING POLYCARBONATE AND POLY BUTYLENE TEREPHTHALATE

(71) Applicant: SABIC GLOBAL TECHNOLOGIES B.V., BERGEN OP ZOOM (NL)

(72) Inventor: Roshan Kumar Jha, Bangalore (IN)

(21) Appl. No.: 17/797,615

(22) PCT Filed: Mar. 19, 2021
(86) PCT No.: PCT/EP2021/057077

§ 371 Date: Aug. 4, 2022

(30) Foreign Application Priority Data
Mar. 20, 2020 (EP) 20164623.9
Mar. 20, 2020 (EP) 20164627.0
Mar. 20, 2020 (EP) 20164651.0

(51) Int. Cl. C08L 69/00; C08L 67/02

(52) U.S. Cl. CPC C08L 69/00; C08L 67/02; C08L 2205/035

(57) ABSTRACT

The present invention relates to a composition comprising at least 60 wt. % aromatic polycarbonate and at most 40 wt. % of polyester comprising poly(butylene terephthalate), based on the combined amounts of aromatic polycarbonate and polyester, from 1-10 wt. % of impact modifier, based on the weight of the composition, wherein the composition comprises the aromatic polycarbonate and the polyester, the aromatic polycarbonate has an endcap level of at least 75 mol % and the aromatic polycarbonate comprises melt polycarbonate.

### CROSS REFERENCE TO RELATED APPLICATIONS

This application is a National Stage application of PCT/EP2021/057077, filed Mar. 19, 2021, which claims the benefit of European Application No. 20164627.0, filed Mar. 20, 2020, European Application No. 20164623.9, filed Mar. 20, 2020, European Application No. 20164651.0, filed Mar. 20, 2020, all of which are incorporated by reference in their entirety herein.

### BACKGROUND

The present invention relates to a composition comprising aromatic polycarbonate, poly(butylene terephthalate) and an impact modifier.

Such compositions are known per se and commercially available for example From SABIC under the tradename XENOY®. Such compositions are commonly referred to as PC/PBT blends or PC/PBT compositions with PC referring to polycarbonate and PBT to polybutylene terephthalate. Applications for PC/PBT compositions include parts for automotive and electronic appliances.

Aromatic polycarbonates are generally manufactured using two different technologies. In the first technology, known as the interfacial technology or interfacial process, phosgene is reacted with bisphenol A (BPA) in a liquid phase. In this process the aromatic polycarbonate chains will grow, i.e. the molecular weight increases, until the reaction is stopped by means of addition of a chain-terminating agent, also referred to as end-capping agent. Typically, such end-capping agents are mono-hydroxy compounds such for example phenol. Due to the nature of the interfacial technology end-capping levels of the aromatic polycarbonate are very high, which means that the aromatic polycarbonate obtained via the interfacial technology will have a relatively low amount of terminal hydroxyl groups at the end of the aromatic polycarbonate chains. Consequently, such aromatic polycarbonates generally have very good long-term heat stability. Although this process produces the desired polymer, there are disadvantages associated with it. For example, phosgene is extremely toxic and hence results in safety concerns. In addition, methylene chloride, which is often used as a solvent in the interfacial process, raises environmental concerns.

Another well-known technology for the manufacture of aromatic polycarbonate is the so-called melt technology, sometimes also referred to as melt transesterification, melt process, or melt polycondensation technology. In the melt technology, or melt process, a bisphenol, typically bisphenol A (BPA), is reacted with a carbonate, typically diphenyl carbonate (DPC), in the melt phase. The reaction between DPC and BPA releases phenol, which needs to be removed from the reaction mixture in order to progress the polymerization reaction. Typically, the melt process is carried out in a number of stages with increasing temperatures and decreasing pressures until a desired molecular weight is obtained. Due to the nature of the melt process, the resulting aromatic polycarbonate typically has a significantly higher amount of terminal hydroxyl groups. Due to this, the obtained aromatic polycarbonate, in comparison with the interfacially manufactured aromatic polycarbonate, has a lower long term heat stability performance. Polycarbonate manufactured with the interfacial process is referred to herein as interfacial polycarbonate whereas polycarbonate manufactured with the melt process is referred to herein as melt polycarbonate.

WO 2014/097196 discloses a composition made by a process comprising melt blending (a) from 10 to 70 weight percent of a partially crystalline polyester component selected from poly(butylene terephthalate), poly(ethylene terephthalate), poly(butylene terephthalate) copolymers, poly(ethylene terephthalate) copolymers, and combinations thereof; (b) from 10 to 60 weight percent of an amorphous polycarbonate having a Fries rearrangement of greater than 150 to 10,000 ppm; (c) from 5 to 50 weight percent of a filler; and (d) optionally, from 0.01 to 10 wt. % of an antioxidant, mold release agent, colorant, stabilizer, or a combination thereof; wherein the melt blended composition has a polycarbonate aryl hydroxy end-group content of at least 300 ppm; and wherein the composition, when molded into an article having a 2.0 mm thickness, provides a near infrared transmission at 960 nanometers of greater than 45%.

WO 2017/093232 discloses a thermoplastic composition comprising 0 to 50 weight percent of a polycarbonate, 10 to 50 weight percent of a polyester carbonate copolymer, 5 to 20 weight percent of a poly(ethylene terephthalate), 20 to 50 weight percent of a poly(butylene terephthalate), and optionally 5 to 30 weight percent of an impact modifier, wherein weight percent is based on the combined amounts of polycarbonate, polyester carbonate copolymer, poly(ethylene terephthalate), poly(butylene terephthalate) and optional impact modifier.

US 2008/0269399 discloses a composition comprising a polyester-polycarbonate polymer comprising isophthalate-terephthalate-resorcinol ester units and carbonate units, a first polyester selected from poly(ethylene-terephthalate), poly(ethylene-isophthalate), or a combination thereof, and a second polyester comprising butylene-terephthalate units, cyclohexanedimethylene terephthalate units, or a combination of cyclohexanedimethylene terephthalate units and ethylene terephthalate units. The polyester polycarbonate polymer in this reference is manufactured using an interfacial process.

### SUMMARY

The present inventors have found that the impact properties of compositions comprising aromatic polycarbonate, poly(butylene terephthalate) and an impact modifier depend not only on the type and/or amount of impact modifier but also on the type of polycarbonate. More in particular the present inventors surprisingly found that the endcap level of the polycarbonate has an effect on the impact performance of such blends. This was found in particular for compositions with a relatively high amount of polycarbonate and a relatively low amount of impact modifier. The present inventors have found that replacing an interfacial polycarbonate by a melt polycarbonate whereby the molecular weight of the polycarbonates as well as the remaining components of the composition were kept similar, may result in a drop in impact energy.

In view of the foregoing it is an object of the invention to provide a PC/PBT composition wherein at least a part of the polycarbonate originates from the melt process and wherein such composition has good impact properties, preferably impact properties within 10% of the impact properties of otherwise identical compositions based entirely on interfacial polycarbonate. A further object of the present invention is to provide a PC/PBT composition wherein at least a part of the polycarbonate originates from the melt process and wherein such composition has both good impact properties as well as good heat resistance properties. In that respect the term heat resistance means the resistance to deformation upon increasing temperature such as typically measured as a Vicat softening temperature and/or a heat distortion temperature, sometimes also referred to as heat deflection temperature.

The present inventors have surprisingly found that these objects can be met, at least in part, when the endcap level of the aromatic polycarbonate of the composition has an endcap of at least 75 mol %.

Accordingly the present invention relates to a composition comprising at least 60 wt. % aromatic polycarbonate and at most 40 wt. % of polyester comprising poly(butylene terephthalate), based on the combined amounts of aromatic polycarbonate and polyester and from 0-10 wt. % of impact modifier, based on the weight of the composition, wherein the aromatic polycarbonate has an endcap level of at least 75 mol % and wherein the aromatic polycarbonate comprises melt polycarbonate.

More specifically the present invention relates to a composition comprising at least 60 wt. % aromatic polycarbonate and at most 40 wt. % of polyester comprising poly(butylene terephthalate), based on the combined amounts of aromatic polycarbonate and polyester, from 1-10 wt. % of impact modifier, based on the weight of the composition, wherein the composition comprises the aromatic polycarbonate and the polyester, the aromatic polycarbonate has an endcap level of at least 75 mol %, preferably at least 80 mol % and the aromatic polycarbonate comprises melt polycarbonate.

### DETAILED DESCRIPTION

A polycarbonate obtained by the melt transesterification process is known to be structurally different from polycarbonate obtained by the interfacial process. In that respect it is noted that in particular melt polycarbonate typically has a minimum amount of Fries branching, which is generally absent in interfacial polycarbonate. In view of the difference between these two processes also the terminal hydroxyl group content typically differs. In the interfacial process typically the end-capping levels of the aromatic polycarbonate are very high 90 mol %) and thereby all of the terminal hydroxyl groups can be end-capped with an endcapping agent so that the terminal hydroxyl group content for interfacial polycarbonate can be as low as 0 ppm. On the other hand the melt polycarbonate process typically results in polycarbonate having a terminal hydroxyl group content of at least about 150 ppm, at least 200 or at least 250 ppm.

Polycarbonate

The aromatic polycarbonate in the composition according to the invention comprises melt polycarbonate and has an endcap level of at least 75 mol %, preferably at least 80 mol %, more preferably at least 85 mol %. The endcap level may be at most 95 mol %, such as at most 90 mol %. For the purpose of the present invention, it is noted that the endcap level is considered as a value measured on the aromatic polycarbonate of the composition.

The aromatic polycarbonate may be a mixture of melt polycarbonate and a polycarbonate not manufactured using the melt process such as the interfacial process, as long as the endcap level is at least 75 mol %. Thus, by way of example an amount of interfacial polycarbonate with an endcap level of about 100 mol % may be mixed with an amount of melt polycarbonate having an endcap level of about 60 mol % as long as the measured endcap level of the mixture is at least 75 mol %.

For the avoidance of doubt the interfacial polycarbonate, if any, may be a mixture of two or more interfacial polycarbonates. Likewise, the melt polycarbonate may be a mixture of two or more melt polycarbonates.

It is preferred that the aromatic polycarbonate contains at least 50 wt. %, more preferably at least 75 wt. %, more preferably at least 95 wt. % of melt polycarbonate, based on the amount of the aromatic polycarbonate. The aromatic polycarbonate may essentially consist or consist of melt polycarbonate provided of course that the aromatic polycarbonate has an endcap level of at least 75 mol %. Thus, if the aromatic polycarbonate consists of melt polycarbonate then the melt polycarbonate has an endcap level of at least 75 mol %. For the purpose of the present invention the term aromatic polycarbonate does not include polyester-polycarbonate (co)polymers.

If the aromatic polycarbonate consists of melt polycarbonate then the melt polycarbonate may be a mixture of two melt polycarbonates, for example a mixture of melt polycarbonates, which mutually differ in molecular weight, Fries branching, and/or endcap level. Preferably, the aromatic polycarbonate consists of a melt polycarbonate with an endcap of at least 75 mol %.

The composition of the invention generally does not comprise polycarbonate other than aromatic polycarbonate. Preferably and for the purpose of the present invention a polyester carbonate, or a polyester polycarbonate copolymer, is/are not considered as an aromatic polycarbonate.

The melt polycarbonate is an aromatic polycarbonate obtained by reacting a bisphenol and a diarylcarbonate, where the bisphenol is preferably bisphenol A (BPA) and the diarylcarbonate is preferably diphenyl carbonate (DPC). The aromatic polycarbonate is preferably a linear aromatic polycarbonate meaning that the melt transesterification is preferably carried out on the basis of the bisphenol and diaryl carbonate in absence of any branching agent, such as for example multi-functional alcohols. For the purpose of the present invention, the melt polycarbonate may however be branched or linear.

Notwithstanding the foregoing it is well known that the melt transesterification process for the manufacture of polycarbonate, wherein bisphenol a and diphenyl carbonate are reacted in molten conditions thereby releasing phenol, results in a certain amount of branching, known as Fries branching. The amount of Fries branching depends inter alia on the type and amount of transesterification catalyst that is used as well as the reaction conditions that are applied, in particular the temperature, pressure and residence times. Thus, a linear polycarbonate in the context of the present invention will contain a certain amount of Fries branching. It is however to be understood that the polycarbonate in the present invention is preferably manufactured in absence of a branching agent, i.e. an agent that includes three or more functional groups and thereby introduces branching or crosslinking of the polycarbonate.

The amount of Fries branching is preferably at least 1000 ppm, at least 1100 ppm, or at least 1200 ppm. And preferably at most 2000 ppm. The amount of Fries branching may be from 1000-2000 ppm, or 1100-2000 ppm or 1100-1700 ppm. The term Fries branching is known to the skilled person and refers inter alia to the structures as disclosed in EP2174970 and reproduced below as structures (1) to (5), yet may include further branched structures.

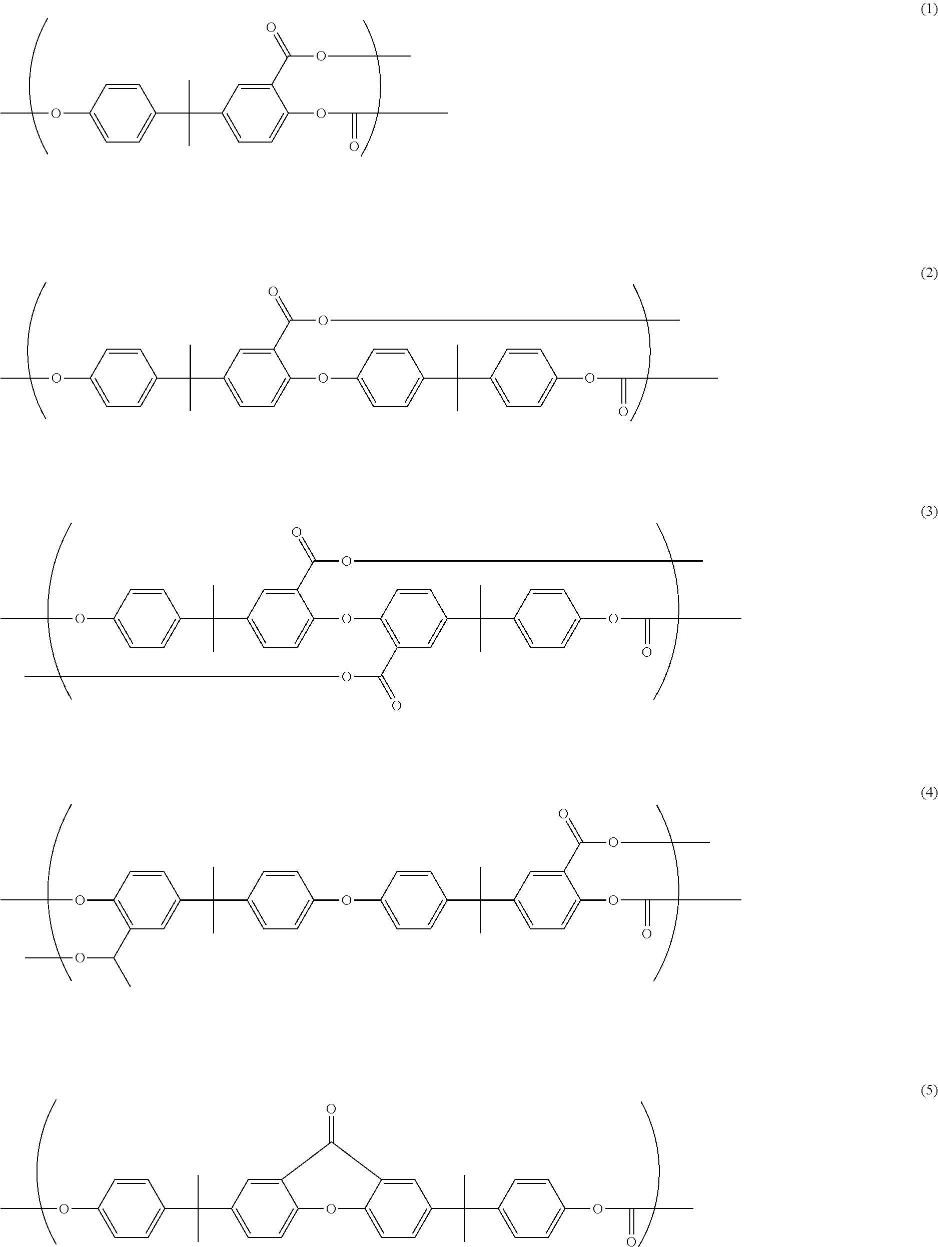

WO 2011/120921 discloses that units such as disclosed in EP 217940 are Fries branching species. Methods for determining the amount of Fries branching are known to the skilled person and generally include the methanolysis of the polycarbonate followed by HPLC chromatography to identify the total amount of Fries structures. In addition, NMR techniques can be used to determine the type and amount of these Fries structures, such as the respective amounts of linear and branched Fries structures.

It is preferred that the polycarbonate has a weight average molecular weight, Mw, of at least 15,000 to 60,000 g/mol, determined on the basis of polystyrene standards.

The desired endcap level of the melt polycarbonate can be obtained in several ways. For example, the endcap level can be set by selecting the appropriate processing conditions during the melt polycondensation reaction. In particular, the ratio of diaryl carbonate to bisphenol and in addition to that, the type and amount of catalyst can be used to control the endcap level.

Alternatively or in addition to this an end-capping agent (also referred to as a chain stopper agent or chain-terminating agent) can be included during polymerization to provide end groups. The end-capping agent (and thus end groups) are selected based on the desired properties of the polycarbonates. The end-capping agent is preferably selected from paracumyl phenol, dicumyl phenol, p-tert-butyl phenol and mixtures of at least two of said end-capping agents.

The amount of end-capping agent to be employed depends on the exact location and conditions of where the end-capping agent is introduced during the melt transesterification process and further on the type and the desired level of end-capping of the polycarbonate.

The endcap level is calculated with the following Formula I

$$\% EC = 100 - ( \frac{ppmOH \times Mn}{340000} ) \qquad I$$

wherein % EC is the endcap level, ppmOH is the amount of hydroxyl end groups in parts per million by weight and Mn is the number average molecular weight of the polycarbonate based on polycarbonate standards.

In accordance with the invention, the aromatic polycarbonate has an endcap level of at least 75 mol % wherein the endcap level is defined as the percentage of polycarbonate chain ends which are not hydroxyl groups. Thus, a polycarbonate having and endcap level of 75 mol % means that the polycarbonate has 25 mol % of chain ends that are phenolic OH end groups, usually resulting from the bisphenol A monomer. The other 75 mol % of end groups do not contain a OH end group and may be phenolic or correspond to the end capping agent molecule(s).

The amount of chain ends that are end-capped with the end-capping agent is preferably at least 25 mol % on the basis of the total amount of end-groups.

The endcap level is defined as the mole percentage of end-groups of the polycarbonate that is not a hydroxyl group and can be calculated from the amount of terminal OH groups in the polycarbonate and the number average molecular weight (Mn) in accordance with Formula I.

It is preferred that the melt polycarbonate is obtained via the melt transesterification of a diaryl carbonate, a bisphenol and an end-capping agent selected from the group consisting of paracumyl phenol, dicumyl phenol, p-tert-butyl phenol and mixtures of at least two of said end-capping agents.

The aromatic polycarbonate in accordance with the invention, whether it consists of melt polycarbonate or is comprised of a mixture comprising melt polycarbonate is preferably bisphenol A polycarbonate homopolymer. Thus, when the aromatic polycarbonate consists of melt polycarbonate then the melt polycarbonate is preferably bisphenol A polycarbonate homopolymer and when the aromatic polycarbonate comprises melt polycarbonate and one or more further polycarbonates, such as interfacial polycarbonate, then preferably all polycarbonate is bisphenol A polycarbonate homopolymer.

The aromatic polycarbonate in accordance with the invention preferably does not comprise a copolymer, such as for example polycarbonate-polysiloxane copolymers.

It is further preferred that apart from aromatic polycarbonate the composition as disclosed herein does not comprise non-aromatic polycarbonate.

Polyester

The polyester of the composition disclosed herein comprises, essentially consists of or consists of poly(butylene terephthalate). The poly(butylene terephthalate) may be a mixture of two or more different poly(butylene terephthalate)s, for example a mixture of poly(butylene terephthalate)s with mutually different molecular weights.

Polyesters like poly(butylene terephthalate) and polyethylene terephthalate are known to a skilled person per se. In a particularly preferred embodiment, the said polyester comprises poly(butylene terephthalate) (PBT).

It is preferred that the poly(butylene terephthalate) has a weight average molecular weight of 50,000 to 150,000 g/mol as determined using gel permeation chromatography with polystyrene standards.

It is preferred that the polyester in the composition contains at least 25 wt. %, preferably at least 50 wt. %, more preferably at least 75 wt. % of poly(butylene terephthalate) based on the amount of polyester. The polyester may also comprise at least 95 wt. % or 99 wt. % of poly(butylene terephthalate) or may essentially consist or consist of poly(butylene terephthalate).

In order to further increase the heat resistance the polyester may comprise another polyester, miscible with poly(butylene terephthalate), having a higher heat resistance compared to the heat resistance of virgin poly(butylene terephthalate). Thus, it is preferred that the polyester comprises a polyester having a higher heat distortion temperature that polybutylene terephthalate. The amount of said further polyester may be from 1 to 20 wt. %, based on the weight of the polyester. Examples of such polyesters are polyethylene naphthalate (PEN), polybutylene naphthalate (PBN), polytrimethylene terephthalate (PTT) and polyethylene terephthalate.

It is particular preferred that the polyester comprises polyethylene terephthalate.

Polyethylene terephthalate is a well-known polyester and readily available. The polyethylene terephthalate may be a mixture of two or more different polyethylene terephthalates, for example a mixture of polyethylene terephthalates with mutually different molecular weights.

If the polyester comprises both polybutylene terephthalate and polyethylene terephthalate then it is preferred that the polyester comprises from 1 to 20 wt. % of poly(ethylene terephthalate) and 99 to 80 wt. % of poly(butylene terephthalate) based on the weight of the polyester. It is preferred that the sum of the amount of poly ethylene terephthalate and polybutylene terephthalate is at least 90 wt. %, preferably at least 95 wt. %, more preferably at least 99 wt. %, most preferably 100 wt. % based on the weight of the polyester.

Other polyester having a similar effect may include polyethylene naphthalate (PEN), Polybutylene naphthalate (PBN), polytrimethylene terephthalate (PTT). It can also include a branched polyester, in which a branching agent, for example, a glycol having three or more hydroxyl groups or a trifunctional or multifunctional carboxylic acid has been incorporated, can be used.

The amount of polyester other than poly(butylene terephthalate), such as in particular polyethylene terephthalate, may be at most 50 wt. %, preferably at most 35 wt. %, more preferably at most 15 wt. % based on the weight of polyester in the composition.

Nucleating Agents

The composition disclosed herein can further include one or more nucleating agents. In that respect, the term nucleating agent refers to an additive that enhances the formation of crystals in the polyester phase of the composition. Addition of a nucleating agent will accordingly increase the crystallinity of the polyester phase, which results in an increased heat resistance. Talc is particularly preferred as nucleating agent. The composition preferably comprises from 0.01 to 5% by weight, with preference from 0.02 to 1% by weight and particularly preferably from 0.05 to 0.2% by weight, of nucleating agents.

Impact Modifiers

The composition of the invention contains from 1-10 wt. % of an impact modifier, based on the weight of the composition. The amount of impact modifier comprised in the composition may be from 1-10 wt. %, preferably from 1-8 wt. % or from 2-7 or from 3-5 wt. % based on the weight of the composition. There is no restriction on the type of impact modifier and any material commonly used in PC/PBT compositions may be used. Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

It is preferred that the impact modifier is selected from the group consisting of ethylene-vinyl acetate copolymer, ethylene-methyl-acrylate copolymer, ethylene-ethyl acrylate copolymer, ethylene-butyl acrylate copolymer, low density polyethylene, maleic anhydride grafted ethylene-octene copolymer, ethylene-ethyl acrylate-glycidyl ester copolymer, ethylene-butyl acrylate-glycidyl ester copolymer, rubber modified styrene-acrylonitrile copolymer, rubber modified styrene-acrylonitrile-methyl methacrylate copolymer, styrene-acrylonitrile copolymer and combinations of at least two of the foregoing (co)polymers.

Other Additives

Typical additives that are used in the composition can comprise one or more of an flow modifier, filler, reinforcing agent (e.g., glass fibers or glass flakes), antioxidant, heat stabilizer, light stabilizer, UV light stabilizer and/or UV absorbing additive, plasticizer, lubricant, release agent, in particular glycerol monostearate, pentaerythritol tetra stearate, glycerol tristearate, stearyl stearate, antistatic agent, antifog agent, antimicrobial agent, colorant (e.g., a dye or pigment), flame retardant either or not combined with an anti-drip agent such as polytetrafluoroethylene (PTFE) or PTFE-encapsulated styrene-acrylonitrile copolymer.

The compositions can be manufactured by various methods known in the art. For example, polycarbonate, poly(butylene terephthalate), poly(ethylene terephthalate), and other components are first blended, optionally with any fillers or additives, in a high speed mixer or by hand mixing. The blend is then fed into the throat of a twin-screw extruder via a hopper. Alternatively, at least one of the components can be incorporated into the composition by feeding it directly into the extruder at the throat and/or downstream through a side feeder, or by being compounded into a masterbatch with a desired polymer and fed into the extruder. The extruder is generally operated at a temperature higher than that necessary to cause the composition to flow. The extrudate can be immediately cooled in a water bath and pelletized. The pellets so prepared can be one-fourth inch long or less as desired. Such pellets can be used for subsequent molding, shaping, or forming.

Shaped, formed, or molded articles comprising the compositions are also provided. The compositions can be molded into useful shaped articles by a variety of methods, such as injection molding, extrusion, blow molding and thermoforming. Some example of articles include automotive and vehicular body panels such as bumper covers and bumpers or a housing for electrical equipment.

Accordingly, the present invention relates to an article comprising or consisting of the composition disclosed herein.

More in particular the present invention relates to vehicular body parts or for housing of electrical equipment comprising or consisting the composition disclosed herein. Likewise, the present invention relates to a vehicle or an electrical equipment comprising said vehicular body part or said housing.

The present invention relates to the use of the composition disclosed herein for the manufacture of an article of manufacture, such as an automotive part.

The present invention further relates to the use of melt aromatic polycarbonate having an endcap level of at least 75 mol % in a composition comprising aromatic polycarbonate and poly(butylene terephthalate) for improving the impact properties of said composition when compared to an otherwise identical composition comprising melt polycarbonate having an endcap level of less than 75 mol %, preferably less than 65 mol %.

Composition

The composition disclosed herein preferably has one or more of:
a Vicat softening point, as determined in accordance with ISO-306 B120 at a load of 50N and a speed of 120° C./hr of at least 90% of the Vicat softening point of an otherwise identical composition wherein the aromatic polycarbonate consists of interfacial polycarbonate,
a heat distortion temperature, as determined in accordance with ISO 75 flatwise at a load of 0.45 MPa, of at least 90% of the heat distortion temperature of an otherwise identical composition wherein the aromatic polycarbonate consists of interfacial polycarbonate, a notched Izod Impact energy as determined in accordance with ASTM D256 at 23° C. measured on an injection moulded sample having a thickness of 3.2 mm, of at least 90% of the notched Izod Impact of an otherwise identical composition wherein the aromatic polycarbonate consists of interfacial polycarbonate.

It is in particular preferred that the composition has a notched Izod Impact energy as determined in accordance with ASTM D256 at 23° C. measured on an injection moulded sample having a thickness of 3.2 mm, of at least 90%, preferably at least 95% of the notched Izod Impact of an otherwise identical composition wherein the aromatic polycarbonate consists of interfacial polycarbonate.

It is preferred that in the composition disclosed herein the aromatic polycarbonate has a weight average molecular weight of 15,000 to 60,000 g/mol when determined using gel permeation chromatography with polycarbonate standards and/or wherein the poly(butylene terephthalate) has a weight average molecular weight of 60,000 to 150,000 g/mol as determined using gel permeation chromatography with polystyrene standards.

In the composition disclosed herein the combined amount of polyester, aromatic polycarbonate and impact modifier is preferably at least 85 wt. %, more preferably at least 90 wt. %, 95 wt. % or 98 wt. % based on the total weight of the composition. It is preferred that the composition comprises at most 10 wt. % preferably at most 5 wt. % of further additives. It is further preferred that the composition as disclosed herein does not contain glass fibers.

The composition according to the invention comprises both aromatic polycarbonate and polyester. The amount of aromatic polycarbonate is at least 60 wt. % and the amount of polyester is at most 40 wt. % based on the combined weight of the aromatic polycarbonate and the polyester. It is preferred that the amount of polycarbonate is from 65-90 wt. % and the amount of polyester from 35-10 wt. %. More preferably the amount of polycarbonate is from 70-85 wt. % and the amount of polyester from 30-15 wt. %, based on the combined weight of the polyester and the polycarbonate.

It is preferred that the composition comprises at most 3 wt. %, based on the weight of the composition, of a filler such as a glass or glassy filler, specifically a glass fiber, a glass flake, and a glass bead, talc, or mica.

It is preferred that the composition does not contain fillers and in particular that the composition does not contain one or more of glass fibers, glass flakes, glass beads talc or mica, provided that talc may be added in an amount of at most 1 wt. %.

The present invention will now be further elucidated based on the following non-limiting examples.

Test Methods

| | |
|---|---|
| Impact | Notched Izod impact properties were determined in accordance |
| | with ASTM D256 on injection moulded samples being 64 × 12.7 × |
| | 3.2 mm in size. The test was carried out at 23° C. The impact energy |
| | is expressed in J/m. Impact strength is calculated by dividing |
| | impact energy in J by the thickness of the specimen. The test result |
| | is the average of 5 specimens. |
| Melt | The melt volume rate was determined in accordance with ASTM |
| volume | D1238. For polycarbonate measurements were carried out at a |
| rate | temperature of 300° C. and a load of 1.2 kg. For the compositions |
| (MVR) | of the examples measurements were carried out at a temperature of |
| | 250° C. and a load of 5.0 kg. |
| Fries | The amount of Fries branching was determined using an Agilent |
| branching | 1100series HPLC equipped with a MWD G1365B detector. The |
| | column is an Agilent Zorbax Eclipse XDB-C18 4.6 × 75 mm. The |
| | injection volume is 50 ml. The oven temperature is 35° C. and the |
| | wavelength to acquire data is 320.16 nm. For sample preparation |
| | 0.3 g of sample is dissolved in 7.5 ml of a solvents mixture based |
| | on 5 ml of tetrahydrofuran and 2.5 ml of a 10% of potassium |
| | hydroxide solution in methanol, after heating this sample at |
| | 40° C. during 20 min, 1.4 ml of acetic acid is added. |
| Intrinsic | The intrinsic viscosity of the polyesters was measured in 1:1 weight |
| viscosity | to weight mixture of phenol: 1,1,2,2-tetrachloro ethane at 30° C. |
| Endcap | The endcap level was determined based on UV measurement to |
| level | determine the amount of terminal OH groups. Combined with the |
| | number average molecular weight the endcap level is then |
| | determined in accordance with Formula I. The UV |
| | spectrophotometer was a Perkin Elmer Lambda 800. |
| | Measurements were carried out on 0.01 g of a polycarbonate |
| | sample diluted in 10 ml of dichloromethane and placed into a quartz |
| | cuvette of 10 mm of optical path. The wavelength to acquire data |
| | are 284 and 292 nm. The results from the equipment as ppm of OH |
| | are used to calculate the endcap using also the molecular weight |
| | of the polycarbonate and according to the formula for calculation |
| | as disclosed herein. |
| Vicat | The Vicat softening point (in ° C.) was determined in accordance |
| softening | with ISO 306 at a load of 50N and a speed of 120° C./hr on |
| temperature | injection molded samples. |
| Heat distortion | The heat distortion temperature, HDT (in ° C.) was determined |
| temperature | in accordance with ISO 75 flatwise at a load of 0.45 MPa. |

Materials

The following materials were used in the experiments.

| | |
|---|---|
| PC1 | Bisphenol A polycarbonate manufactured using an interfacial process, |
| | having a melt volume rate of 6 cc/10 min, and endcap level of about 100% |
| | and a Fries branching level of less than 100 ppm, available from SABIC. |
| | Para-cumyl phenol was used as an endcapping agent. |
| PC2 | Bisphenol A polycarbonate manufactured using a melt transesterification |
| | process, having a melt volume rate of 6 cc/10 min, and endcap level of |
| | 65% and a Fries branching level of 1100 ppm. |
| PC3 | Bisphenol A polycarbonate manufactured using a melt transesterification |
| | process, having a melt volume rate of 6 cc/10 min, and endcap level of |
| | 85% and a Fries branching level of 1100 ppm |
| PC4 | Bisphenol A polycarbonate manufactured using a melt transesterification |
| | process, having a melt volume rate of 6 cc/10 min, and endcap level of |
| | 85% and a Fries branching level of 1400 ppm. |
| PC5 | Bisphenol A polycarbonate manufactured using an interfacial process, |
| | having a melt volume rate of 26 cc/10 min, and endcap level of about 100% |
| | and a Fries branching level of less than 100 ppm, available from SABIC. |
| | Para-cumyl phenol was used as an endcapping agent. |
| PC6 | Bisphenol A polycarbonate manufactured using a melt transesterification |
| | process, having a melt volume rate of 26 cc/10 min, and endcap level of |
| | 65% and a Fries branching level of 1100 ppm. |
| PBT | A polybutylene terephthalate having an intrinsic viscosity of 1.2 dl/g as |
| | measured in 1:1 weight to weight mixture of phenol: 1,1,2,2-tetrachloro |
| | ethane at 30° C., commercially available from Chang Chun Plastics, |
| | Taiwan under the grade name CCP PBT 1100. |
| IM1 | Reactive elastomeric ethylene acrylate terpolymer, having a density of |
| | 0.94 g/cm³, a melt flow rate of 8 g/10 min (ISO 1133, 190° C., 21.6 kg) |
| | commercially available as Elvaloy 4170 from DOW. IM1 is used as an |
| | impact modifier. |
| IM2 | MBS impact modifier, commercially available from Dow Chemical as |
| | Paraloid EXL 2550J. |
| Quencher | Mono sodium phosphate |
| AO1 | Primary antioxidant, Octadecyl β-(3,5-di-tert-butyl-4-hydroxy phenyl)- |
| | propionate, CAS 2082-79-3, Commercially available as Irganox 1076 |
| AO2 | Secondary antioxidant, tris(2,4-di-tert.-butylphenyl)phosphite, CAS |
| | 31570-04-4, commercially available from BASF as Irgafos 168 |

TABLE 1

| | | CE1 | CE2 | E1 | E2 | CE3 | E3 | E4 |
|---|---|---|---|---|---|---|---|---|
| PC1 | [wt. %] | 57.3 | | | | 10 | 20 | 30 |
| PC2 | [wt. %] | | 57.3 | | | 57.3 | 47.3 | 37.3 |
| PC3 | [wt. %] | | | 57.3 | | | | |
| PC4 | [wt. %] | | | | 57.3 | | | |
| PC5 | [wt. %] | 10 | | | | | | |
| PC6 | [wt. %] | | 10 | 10 | 10 | | | |
| PBT | [wt. %] | 30 | 30 | 30 | 30 | 30 | 30 | 30 |
| IM1 | [wt. %] | 2 | 2 | 2 | 2 | 2 | 2 | 2 |
| IM2 | [wt. %] | | | | | | | |
| Quencher | [wt. %] | 0.3 | 0.3 | 0.3 | 0.3 | 0.3 | 0.3 | 0.3 |
| AO1 | [wt. %] | 0.2 | 0.2 | 0.2 | 0.2 | 0.2 | 0.2 | 0.2 |
| AO2 | [wt. %] | 0.2 | 0.2 | 0.2 | 0.2 | 0.2 | 0.2 | 0.2 |
| EC | [%] | 100 | 65 | 82 | 82 | 70* | 75* | 81* |
| NII | [J/m] | 769 | 146 | 739 | 473 | 691 | 708 | 741 |
| (23° C.) | | | | | | | | |
| NII | [J/m] | 102 | 84 | 89 | 82 | 108 | 106 | 108 |
| (−30° C.) | | | | | | | | |

*For CE3, E3 and E4 the EC was calculated based on the EC's of the polycarbonates assuming the Mn is identical.

From Table 1 it may be appreciated that the endcap level of the polycarbonate is relevant to the impact performance of the composition. Thus, by way of example a comparison of CE2 CE1 shows that the use of melt polycarbonate (with a low endcap level) provides for a composition having a relatively low impact energy compared to an otherwise identical composition containing interfacial polycarbonate (with a high endcap level). The effect of mixing interfacial polycarbonate with melt polycarbonate is shown by means of examples CE3, E3 and E4.

TABLE 2

| | | CE3 | E5 | CE4 | E6 | CE5 | E7 |
|---|---|---|---|---|---|---|---|
| PC1 | [wt. %] | 57.3 | | 55.4 | | 52.6 | |
| PC2 | [wt. %] | | | | | | |
| PC3 | [wt. %] | | 57.3 | | 55.4 | | 52.6 |
| PC4 | [wt. %] | | | | | | |
| PC5 | [wt. %] | 10.0 | | 9.8 | | 9.2 | |
| PC6 | [wt. %] | | 10.0 | | 9.8 | | 9.2 |
| PBT | [wt. %] | 30.0 | 30.0 | 29.1 | 29.1 | 27.5 | 27.5 |
| IM1 | [wt. %] | | | | | | |
| IM2 | [wt. %] | 2.0 | 2.0 | 5.0 | 5.0 | 10.0 | 10.0 |
| Quencher | [wt. %] | 0.3 | 0.3 | 0.3 | 0.3 | 0.3 | 0.3 |
| AO1 | [wt. %] | 0.2 | 0.2 | 0.2 | 0.2 | 0.2 | 0.2 |
| AO2 | [wt. %] | 0.2 | 0.2 | 0.2 | 0.2 | 0.2 | 0.2 |
| EC | [%] | 100 | 82* | 100 | 82* | 100 | 82* |
| NII | [J/m] | 682 | 127 | 740 | 718 | 705 | 707 |
| (23° C.) | | | | | | | |
| NII | [J/m] | 104 | 98 | 368 | 178 | 662 | 633 |
| (−30° C.) | | | | | | | |

*Calculated based on the EC's of the polycarbonates assuming the Mn is identical.

The experimental data in Table 2 shows that the effect observed in Table 1 is also seen when a different impact modifier is used and further that if the amount of impact modifier in the composition is increased that the effect of the endcap level of the polycarbonate on the impact energy becomes less dominant compared to the effect of the impact modifier.

TABLE 3

| | | E8 | E9 | E10 | E11 | E12 |
|---|---|---|---|---|---|---|
| PC1 | [wt. %] | | | | | |
| PC2 | [wt. %] | | | | | |
| PC3 | [wt. %] | 55.5 | 52.6 | 65.7 | 48.7 | 40.2 |
| PC4 | [wt. %] | | | | | |
| PC5 | [wt. %] | | | | | |
| PC6 | [wt. %] | 9.7 | 9.2 | 11.6 | 8.6 | 7.1 |
| PBT | [wt. %] | 29.1 | 27.5 | 20.0 | 40.0 | 50.0 |
| IM1 | [wt. %] | 5.0 | 10.0 | 2.0 | 2.0 | 2.0 |
| IM2 | [wt. %] | | | | | |
| Quencher | [wt. %] | 0.3 | 0.3 | 0.3 | 0.3 | 0.3 |
| AO1 | [wt. %] | 0.2 | 0.2 | 0.2 | 0.2 | 0.2 |
| AO2 | [wt. %] | 0.2 | 0.2 | 0.2 | 0.2 | 0.2 |
| EC | [%] | 82* | 82* | 82* | 82* | 82* |
| NII | [J/m] | 870 | 837 | 839 | 150 | 115 |
| (23° C.) | | | | | | |
| NII | [J/m] | 202 | 248 | 120 | 104 | 87 |
| (−30° C.) | | | | | | |

*Calculated based on the EC's of the polycarbonates assuming the Mn is identical.

Table 3 shows inter alia the effect of the amount of polycarbonate on the impact energy. More in particular it may derived from Table 3 that if the amount of polycarbonate in the composition drops below 60 wt. % that the impact energy also drops significantly.

In the Tables 1-3 above all amounts displayed are in wt. % on the basis of the weight of the composition. Further comparison of individual data points disclosed in these tables further support the technical effects of the invention as disclosed herein.

1. A composition comprising
at least 60 wt. % an aromatic polycarbonate and at most 40 wt. % of a polyester comprising poly(butylene terephthalate), based on the combined amounts of the aromatic polycarbonate and the polyester; and
from 1-10 wt. % of an impact modifier, based on the weight of the composition,
wherein
the composition comprises the aromatic polycarbonate and the polyester,
the aromatic polycarbonate has an endcap level of at least 75 mol %, and
the aromatic polycarbonate comprises a melt polycarbonate.

2. The composition of claim 1, wherein the composition has one or more of:
a Vicat softening point, as determined in accordance with ISO-306 B120 at a load of 50N and a speed of 120° C./hr of at least 90% of the Vicat softening point of an otherwise identical composition wherein the aromatic polycarbonate consists of an interfacial polycarbonate,
a heat distortion temperature, as determined in accordance with ISO 75 flatwise at a load of 0.45 MPa, of at least 90% of the heat distortion temperature of an otherwise identical composition wherein the aromatic polycarbonate consists of an interfacial polycarbonate,
a notched Izod Impact energy as determined in accordance with ASTM D256 at 23° C. measured on an injection moulded sample having a thickness of 3.2 mm, of at least 90% of the notched Izod Impact of an otherwise identical composition wherein the aromatic polycarbonate consists of an interfacial polycarbonate.

3. The composition of claim 1 wherein the melt polycarbonate is obtained via a melt transesterification of a diaryl carbonate, a bisphenol and optionally an end-capping agent selected from the group consisting of paracumyl phenol, dicumyl phenol, p-tert-butyl phenol and mixtures of at least two of said end-capping agents.

4. The composition of claim 1, wherein the amount of impact modifier is from 1-7 wt. %.

5. The composition of claim 1 further comprising a nucleating agent.

6. The composition of claim 1 wherein the aromatic polycarbonate contains at least 50 wt. %, the melt polycarbonate, based on the amount of aromatic polycarbonate.

7. The composition of claim 1, wherein the polyester further comprises poly(ethylene terephthalate).

8. The composition of claim 1 wherein the polyester comprises from 1 to 20 wt. % of a poly(ethylene terephthalate) and 99 to 80 wt. % of a poly(butylene terephthalate) based on the weight of the polyester.

9. The composition of claim 1 wherein the impact modifier is selected from the group consisting of ethylene-vinyl acetate copolymer, ethylene-methyl-acrylate copolymer, ethylene-ethyl acrylate copolymer, ethylene-butyl acrylate copolymer, low density polyethylene, maleic anhydride grafted ethylene-octene copolymer, ethylene-ethyl acrylate-glycidyl ester copolymer, ethylene-butyl acrylate-glycidyl ester copolymer, rubber modified styrene-acrylonitrile copolymer, rubber modified styrene-acrylonitrile-methyl methacrylate copolymer, styrene-acrylonitrile copolymer and combinations of at least two of the foregoing (co)polymers.

10. The composition of claim 1 wherein the aromatic polycarbonate has a weight average molecular weight of 15,000 to 60,000 g/mol when determined using gel permeation chromatography with polycarbonate standards and/or wherein the poly(butylene terephthalate) has a weight average molecular weight of 60,000 to 150,000 g/mol as determined using gel permeation chromatography with polystyrene standards.

11. The composition of claim 1 wherein the combined amount of the polyester, the aromatic polycarbonate and the impact modifier is at least 85 wt. % based on the weight of the composition.

12. An article comprising or consisting of the composition of claim 1.

13. A vehicle or an electrical equipment comprising the article of claim 12.

14. The article of claim 12, wherein the article is an automotive part.

15. (canceled)

16. The composition of claim 1, wherein the aromatic polycarbonate has an endcap level of at least 80 mol %.
